(19) United States
(12) Patent Application Publication
(10) Pub. No.: US 2025/0316941 A1
(43) Pub. Date: Oct. 9, 2025

(54) Automatic Tin-Plating Sleeve Insertion Machine and Method for Inserting Sleeves

(71) Applicants: Limin Zhuang, Dongguan City (CN); Wenyi Chen, Dongguan City (CN)

(72) Inventors: Limin Zhuang, Dongguan City (CN); Wenyi Chen, Dongguan City (CN)

(21) Appl. No.: 19/017,744

(22) Filed: Jan. 12, 2025

(30) Foreign Application Priority Data
Apr. 9, 2024 (CN) 2024104210074

(51) Int. Cl. H01R 43/28; B23K 1/00; B23K 101/38

(52) U.S. Cl. CPC H01R 43/28; B23K 1/0016; B23K 2101/38

(57) ABSTRACT

An automatic tin-plating sleeve insertion machine includes a machine frame, a wire supply mechanism, a twisting mechanism, a rosin flux application mechanism, a tin-dipping mechanism, a wire feeding mechanism, a rotary disc transfer mechanism, a tube supply mechanism, a first hot air spraying mechanism, a direction-changing mechanism, and a second hot air spraying mechanism. These components are arranged so that the tube supply mechanism, the wire feeding mechanism, the first hot air spraying mechanism, and the direction-changing mechanism surround the rotary disc transfer mechanism, with the second hot air spraying mechanism below the direction-changing mechanism. The rosin flux application mechanism and the tin-dipping mechanism lie between the wire feeding mechanism and the twisting mechanism. The wire supply mechanism passes a wire through twisting, rosin flux application, and tin-dipping to ensure uniform coating, improving subsequent soldering, the tube supply mechanism provides a heat-shrink tube to the rotary disc transfer mechanism.

### TECHNICAL FIELD

The present invention relates to the technical field of wire production and processing, and specifically to an automatic tin-plating sleeve insertion machine and a method for inserting sleeves.

### BACKGROUND

Nowadays, electronic products have become indispensable consumer goods in people's daily lives. With the continuous development of various electronic products, the internal connection cables thereof are also being continuously improved so as to enhance electrical connection efficiency. In order to ensure production efficiency, the connecting wires required for electronic products are often processed into semi-finished products, and thus tin-plating sleeve insertion equipment has emerged. For example, Chinese Patent Application No. 201921612598.4 discloses a “connection line sleeve insertion terminal tin-dipping all-in-one machine,” which solves the problems arising from the traditional cable processing that requires multiple devices, resulting in high labor demands, poor precision, low efficiency, and non-smooth production. However, this apparatus still has the following issues:

The wire feeding device 10 uses several first rollers 13 and second rollers 14 to transfer the wire. Since the rollers contact the wire at a single point, the friction force during the transfer is insufficient, making stable transportation impossible.

When adopting multi-stranded braided wire, it is impossible to ensure that the terminal of every wire strand is tinned.

In view of the above, the present inventor proposes the following technical solutions.

### SUMMARY OF THE INVENTION

The objective of the present invention is to overcome deficiencies in the prior art and to provide an automatic tin-plating sleeve insertion machine and a method for inserting sleeves.

In order to solve the aforementioned technical problems, the present invention adopts the following first technical solution:

An automatic tin-plating sleeve insertion machine, comprising: a wire feeding mechanism, wherein the wire feeding mechanism includes an upper wire feeding module and a lower wire feeding module, which are arranged in an up-down symmetrical manner for clamping and transferring the wire, a first clamping drive device for driving the upper wire feeding module and the lower wire feeding module to move toward and away from each other, and a first positioning sleeve and a second positioning sleeve arranged on both sides of the upper wire feeding module and the lower wire feeding module for guiding and positioning the wire therethrough; the upper wire feeding module and the lower wire feeding module are respectively provided with a first toothed belt and a second toothed belt which can mesh with each other and press the wire during transmission, and the upper wire feeding module and the lower wire feeding module are further respectively provided with a first guide wheel and a second guide wheel for horizontally supporting the first toothed belt and the second toothed belt to realize multi-tooth meshing and clamping of the wire.

Further, in the above technical solution, the upper wire feeding module includes a first support base in the shape of a “concave” ( [symbol] ) character, a first toothed belt sleeved on the first support base, a first gear disposed in the central recess of the first support base and configured to drive the first toothed belt to move, four first guide wheels disposed at the four corners of the first support base for the running of the first toothed belt, and a first motor configured to drive the first gear to operate. The teeth of the first toothed belt are located on the outer side and form a U-shaped bend to mesh with the first gear. The structure of the lower wire feeding module is identical to that of the upper wire feeding module.

Further, in the above technical solution, the wire feeding mechanism also includes a support vertical plate configured to support and position the upper wire feeding module and the lower wire feeding module in motion. The upper wire feeding module also includes a support moving plate arranged in a first positioning groove located in the middle of the support vertical plate. The first support base and the first motor are mounted on opposite sides of the support moving plate. One side of the support vertical plate is provided with a first straightening device for straightening the wire entering between the upper wire feeding module and the lower wire feeding module. A hand-adjustable pulley wire guide device is provided between the first straightening device and the first positioning sleeve for manually adjusting the wire, and on the other side of the support vertical plate, there is a clamping and feeding device for cutting the wire and inserting it into a heat-shrink tube.

Further, in the above technical solution, the wire feeding mechanism also includes a first support frame mounted on the machine frame and a first horizontal motion module mounted on the first support frame, capable of moving toward or away from a rotary disc transfer mechanism. The first straightening device, the hand-adjustable pulley wire guide device, the support vertical plate, and the clamping and feeding device are sequentially installed on the first horizontal motion module. A second clamping device for clamping the wire is additionally provided between the first straightening device and the hand-adjustable pulley wire guide device.

Further, in the above technical solution, the clamping and feeding device includes a sliding adjustment device for supporting the second positioning sleeve, a lifting adjustment device disposed above the sliding adjustment device, a first cutting device arranged on the lifting adjustment device for cutting the wire, and a third wire clamping device and a fourth wire clamping device arranged on both sides of the first cutting device for clamping the wire. A spacer is provided on the third wire clamping device and/or the fourth wire clamping device for increasing the clamping force, and this spacer is located at the connection between a clamp cylinder and a clamp arm.

Further, in the above technical solution, the first clamping drive device includes a second gear, a first rack and a second rack respectively disposed on two sides of the second gear and respectively connected to the upper wire feeding module and the lower wire feeding module, and a first air cylinder connected to the first rack or the second rack for pushing them to move relative to each other.

Further, in the above technical solution, the wire feeding mechanism is arranged in the middle portion of the machine frame. The machine frame is further provided with a wire supply mechanism, a twisting mechanism, a rosin flux application mechanism, a tin-dipping mechanism, a rotary disc transfer mechanism, a tube supply mechanism, a first hot air spraying mechanism, a direction-changing mechanism, and a second hot air spraying mechanism. The tube supply mechanism, the wire feeding mechanism, the first hot air spraying mechanism, and the direction-changing mechanism are arranged in sequence around the periphery of the rotary disc transfer mechanism. The second hot air spraying mechanism is located below the direction-changing mechanism, while the rosin flux application mechanism and the tin-dipping mechanism are located between the wire feeding mechanism and the twisting mechanism. The wire supply mechanism provides the wire to the wire feeding mechanism via the twisting mechanism, the rosin flux application mechanism, and the tin-dipping mechanism. The tube supply mechanism supplies heat-shrink tubes to the rotary disc transfer mechanism. The first hot air spraying mechanism and the second hot air spraying mechanism heat and bond the two ends of the heat-shrink tube sleeved onto the wire.

Further, in the above technical solution, the twisting mechanism includes a hollow rotary cylinder, a support arm arranged on a rotating disk of the hollow rotary cylinder, and a fifth wire clamping device disposed on the support arm for clamping the wire. The fifth wire clamping device clamps the wire and twists it about the rotation center of the hollow rotary cylinder. The wire supply mechanism includes a wire supply reel arranged below the twisting mechanism, a wire guide wheel assembly disposed to one side of the twisting mechanism for conveying the wire, a tension adjustment device arranged between the wire guide wheel assembly and the wire supply reel, a second straightening device arranged between the twisting mechanism and the wire guide wheel assembly, and a second driving device for driving the wire supply reel to rotate and feed the wire.

Further, in the above technical solution, the rotary disc transfer mechanism includes a rotary driving device mounted on the machine frame, a transfer turntable arranged on the rotary driving device, multiple clamp modules arranged around the circumference of the transfer turntable for clamping the heat-shrink tube, and multiple first opening clamp devices arranged below the transfer turntable for pushing open the clamp modules. Each clamp module includes a fixed clamp block arranged on the outer edge of the transfer turntable, a sliding clamp block capable of relative opening and closing motion with respect to the fixed clamp block to clamp the heat-shrink tube, at least one set of first slider-and-guide-rail assemblies arranged on the transfer turntable for sliding motion of the sliding clamp block, an installation fixing plate disposed at one end of the first slider-and-guide-rail assembly to limit and position the sliding clamp block, a return spring disposed between the installation fixing plate and the sliding clamp block for biasing the sliding clamp block toward the fixed clamp block, an opening clamp arm disposed below the sliding clamp block that can contact the first opening clamp device to compress the return spring, and an adjustment bolt rod passing through the installation fixing plate and connecting with the sliding clamp block.

In order to solve the aforementioned technical problems, the present invention also adopts the following second technical solution:

An automatic tin-plating sleeve insertion method, comprising: a machine frame, a wire supply mechanism, a twisting mechanism, a rosin flux application mechanism, a tin-dipping mechanism, a wire feeding mechanism, a rotary disc transfer mechanism, a tube supply mechanism, a first hot air spraying mechanism, a direction-changing mechanism, and a second hot air spraying mechanism.

First, the heat-shrink tube (2) is provided by the tube supply mechanism and transferred to the rotary disc transfer mechanism after being cut. The wire is provided by the wire supply mechanism and, after passing through the twisting mechanism, the rosin flux application mechanism, and the tin-dipping mechanism, is cut by the wire feeding mechanism and inserted into the heat-shrink tube (2) on the rotary disc transfer mechanism.

Furthermore, after passing through the twisting mechanism, the wire is coated on its surface with rosin flux by the rosin flux application mechanism and tinned on its surface by the tin-dipping mechanism. During this process, the twisting mechanism clamps the wire and drives it to twist so that the entire outer surface of the wire is coated with the rosin flux and tin.

Furthermore, the front end of the wire is clamped by the cooperation of the upper wire feeding module and the lower wire feeding module of the wire feeding mechanism, and is pushed forward with the drive of the upper wire feeding module and the lower wire feeding module. After passing through the clamping and feeding device, the wire is inserted into the heat-shrink tube (2) on the rotary disc transfer mechanism, and the wire is cut off by the clamping and feeding device.

Furthermore, the rotary disc transfer mechanism drives the wire inserted into the heat-shrink tube (2) to rotate to the first hot air spraying mechanism. The first hot air spraying mechanism heats one end of the heat-shrink tube and the wire so that the heat-shrink tube wraps and adheres to the wire.

Furthermore, the rotary disc transfer mechanism drives the wire inserted into the heat-shrink tube (2) to rotate to the direction-changing mechanism. The direction-changing mechanism clamps and removes the wire and the heat-shrink tube from the rotary disc transfer mechanism, then moves downward to place the other end of the wire and the heat-shrink tube in front of the second hot air spraying mechanism. By means of the second hot air spraying mechanism, the other end of the heat-shrink tube and wire is heated so that the other end of the heat-shrink tube is partially or completely wrapped around the wire.

Finally, the wire and the heat-shrink tube, whose sleeve bonding has been completed, are discharged from the direction-changing mechanism.

By adopting the above technical solution, the present invention, compared to the prior art, has the following beneficial effects:

In this invention, the wire sequentially passes through the twisting mechanism, the rosin flux application mechanism, and the tin-dipping mechanism to arrive at the wire feeding mechanism. The twisting mechanism is used to twist the wire, causing the periphery of the wire to be evenly coated with rosin flux and tin, thereby preventing a thicker wire or multi-stranded wire harness from failing to be uniformly coated with rosin flux and tin, and greatly improving the pass rate of subsequent soldering.

In this invention, the wire feeding mechanism is provided with the first toothed belt and the second toothed belt to clamp the wire in a meshing form. As the first toothed belt and the second toothed belt operate, the wire is steadily pushed forward. The toothed portions of the first toothed belt and the second toothed belt increase the contact stability with the wire, and the elastic toothed portions of the belts clamp the wire.

### BRIEF DESCRIPTION OF THE DRAWINGS

FIG. 1 is a first structural schematic diagram of the present invention;

FIG. 2 is a structural schematic diagram of the wire feeding mechanism in the present invention;

FIG. 3 is a structural schematic diagram of the upper wire feeding module in the present invention;

FIG. 4 is a structural schematic diagram of the first clamping drive device in the present invention;

FIG. 5 is an enlarged partial view of X in FIG. 4;

FIG. 6 is a structural schematic diagram of the clamping and feeding device in the present invention;

FIG. 7 is a structural schematic diagram of the rotary disc transfer mechanism in the present invention;

FIG. 8 is a structural schematic diagram of the tube supply mechanism in the present invention;

FIG. 9 is a structural schematic diagram of the first hot air spraying mechanism in the present invention;

FIG. 10 is a structural schematic diagram of the direction-changing mechanism in the present invention;

FIG. 11 is a second structural schematic diagram of the present invention.

### DETAILED DESCRIPTION

Below, the present invention is further described with reference to specific embodiments and the accompanying drawings.

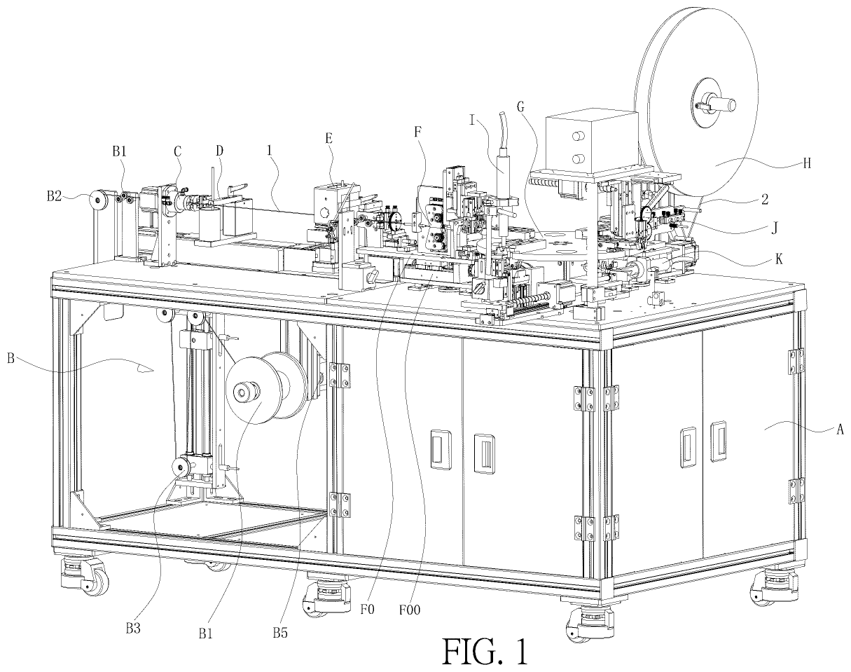

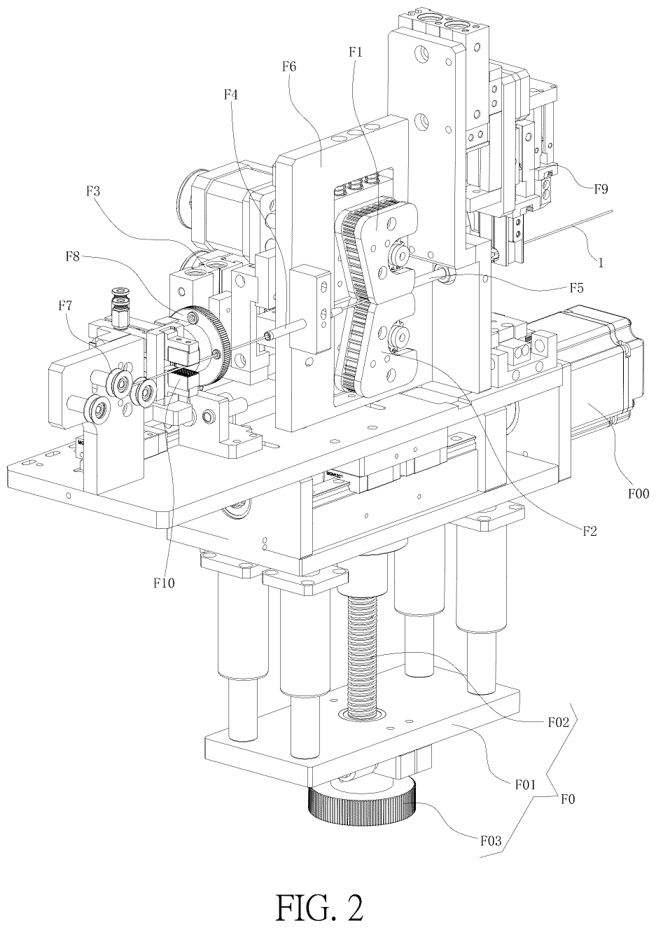

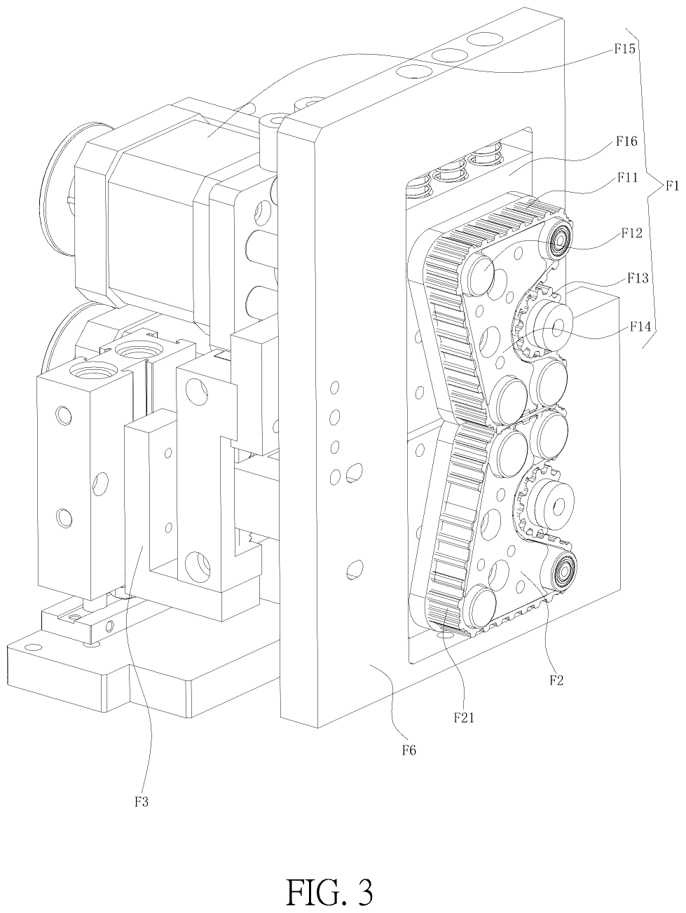

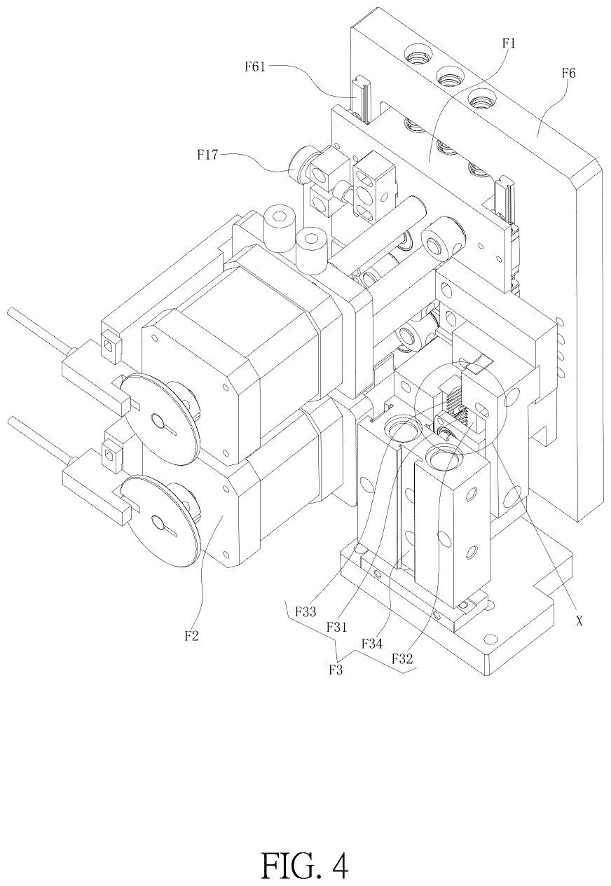

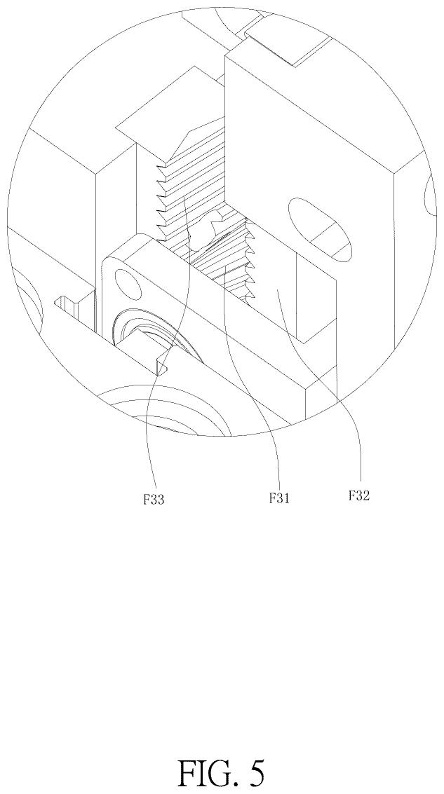

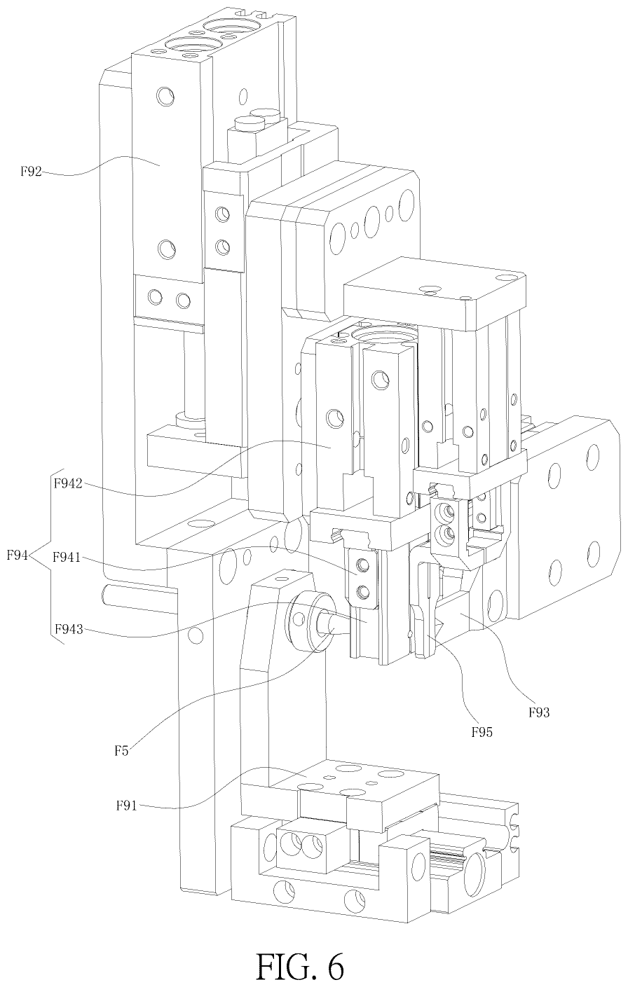

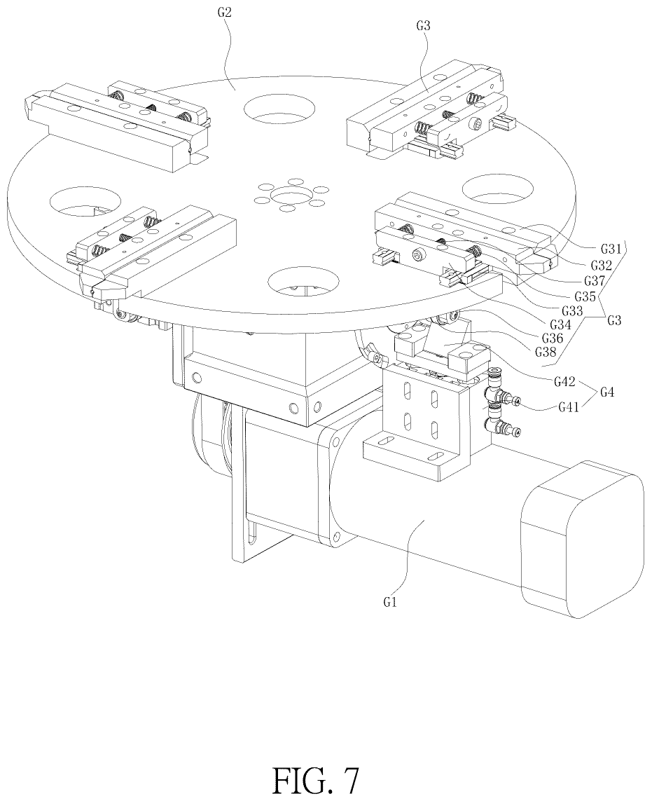

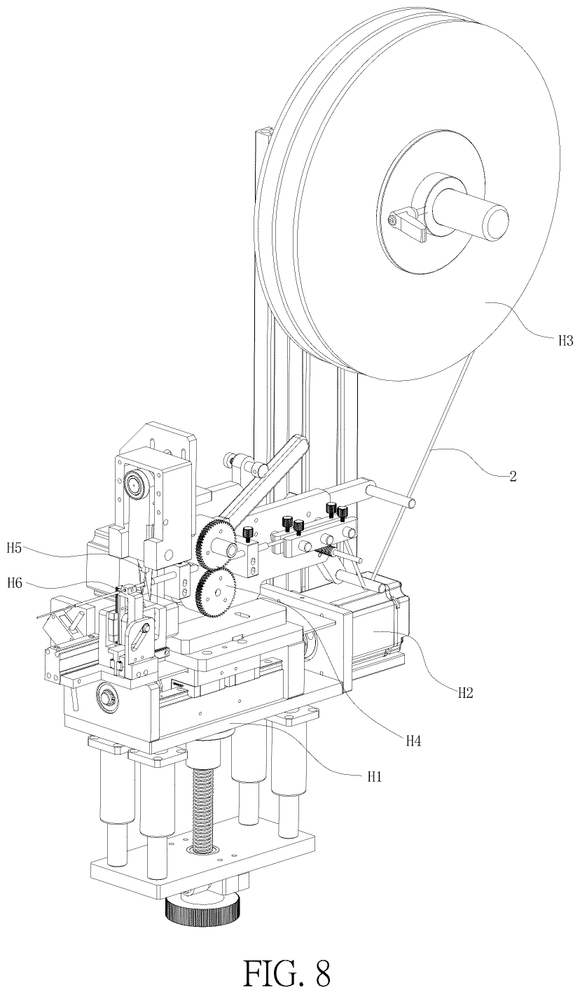

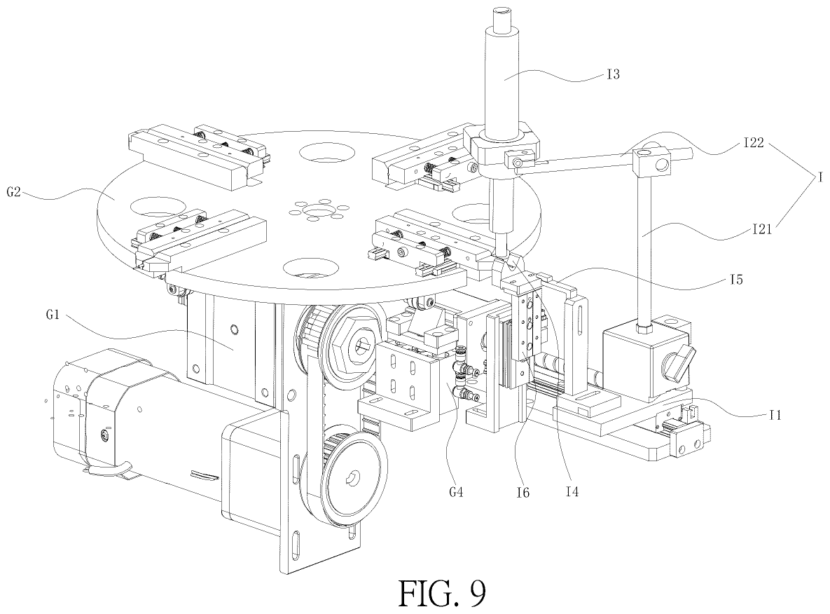

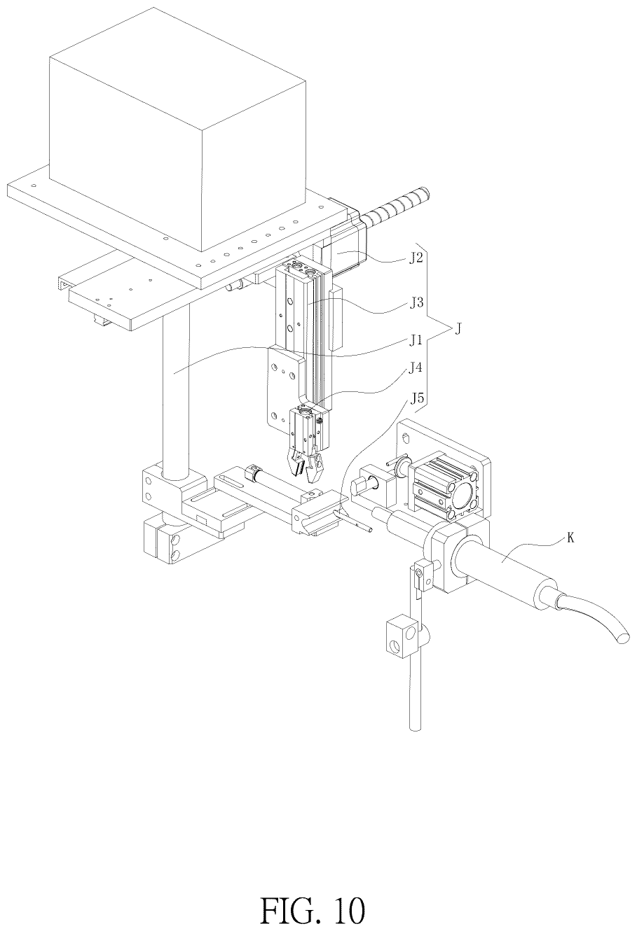

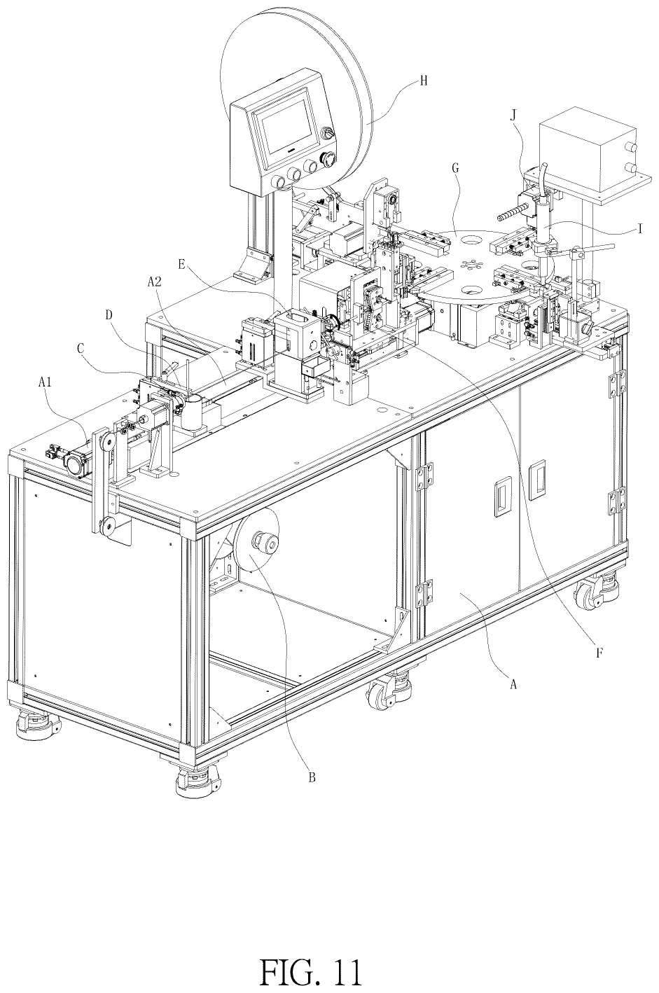

Referring to FIGS. 1 to 11, an automatic tin-plating sleeve insertion machine is provided. It includes: a machine frame A, a wire supply mechanism B, a twisting mechanism C, a rosin flux application mechanism D, a tin-dipping mechanism E, a wire feeding mechanism F, a rotary disc transfer mechanism G, a tube supply mechanism H, a first hot air spraying mechanism I, a direction-changing mechanism J, and a second hot air spraying mechanism K. The tube supply mechanism H, the wire feeding mechanism F, the first hot air spraying mechanism I, and the direction-changing mechanism J are arranged in sequence around the periphery of the rotary disc transfer mechanism G. The second hot air spraying mechanism K is located below the direction-changing mechanism J. The rosin flux application mechanism D and the tin-dipping mechanism E are disposed between the wire feeding mechanism F and the twisting mechanism C. The wire supply mechanism B provides the wire 1 to the wire feeding mechanism F via the twisting mechanism C, the rosin flux application mechanism D, and the tin-dipping mechanism E. The tube supply mechanism H provides heat-shrink tubes 2 to the rotary disc transfer mechanism G. The first hot air spraying mechanism I and the second hot air spraying mechanism K heat and bond the two ends of the heat-shrink tube 2 sleeved on the wire 1. By sequentially passing the wire 1 through the twisting mechanism C, the rosin flux application mechanism D, and the tin-dipping mechanism E to the wire feeding mechanism F, the twisting mechanism C twists the wire 1 so that the entire periphery of the wire 1 is coated with rosin flux and tin, thus preventing thicker or multi-stranded wires from failing to be uniformly coated, and significantly improving the pass rate of subsequent soldering.

The wire feeding mechanism F includes an upper wire feeding module F1 and a lower wire feeding module F2, arranged in an up-down symmetrical manner to clamp and transmit the wire 1, a first clamping drive device F3 for driving the upper wire feeding module F1 and the lower wire feeding module F2 to move toward and away from each other, and a first positioning sleeve F4 and a second positioning sleeve F5 arranged on both sides of the upper wire feeding module F1 and the lower wire feeding module F2 for guiding and positioning the wire 1. The upper wire feeding module F1 and the lower wire feeding module F2 are respectively provided with a first toothed belt F11 and a second toothed belt F21, both of which can mesh with each other and press the wire 1 during transportation. By providing the first toothed belt F11 and the second toothed belt F21 in the wire feeding mechanism F to clamp the wire 1 in a meshing form, the wire 1 is steadily pushed forward with the operation of the first toothed belt F11 and the second toothed belt F21. The toothed portions of the first toothed belt F11 and the second toothed belt F21 enhance contact stability with the wire 1, and the elastic toothed portions of the belts clamp the wire 1. The first toothed belt F11 and the second toothed belt F21 are made of flexible materials, including but not limited to plastic and silicone.

The upper wire feeding module F1 includes a first support base F12 in the shape of a “concave” ( [symbol] ) character, a first toothed belt F11 sleeved on the first support base F12, a first gear F13 disposed in the middle recess of the first support base F12 for driving the first toothed belt F11 to move, four first guide wheels F14 disposed at the four corners of the first support base F12 for the running of the first toothed belt F11, and a first motor F15 for driving the first gear F13 to operate. The toothed portion of the first toothed belt F11 is located on the outside and forms a U-shaped bend that meshes with the first gear F13. The structure of the lower wire feeding module F2 is identical to that of the upper wire feeding module F1. Specifically, among the four first guide wheels F14, two are horizontally positioned on the upper and lower sides of the first support base F12 to hold the first toothed belt F11 and the second toothed belt F21 in a horizontal expanded state, achieving multi-tooth meshing between the first toothed belt F11 and the second toothed belt F21. This significantly increases the contact area with the wire 1 and enhances the stability of its transmission.

The wire feeding mechanism F further includes a support vertical plate F6 for supporting and positioning the upper wire feeding module F1 and the lower wire feeding module F2 in motion. The upper wire feeding module F1 also includes a support moving plate F16 disposed in a first positioning groove in the middle of the support vertical plate F6. The first support base F12 and the first motor F15 are respectively mounted on opposite sides of the support moving plate F16. One side of the support vertical plate F6 is provided with a first straightening device F7 for straightening the wire 1 before it enters between the upper wire feeding module F1 and the lower wire feeding module F2. A hand-adjustable pulley wire guide device F8 is disposed between the first straightening device F7 and the first positioning sleeve F4 to enable manual adjustment of the wire 1. On the other side of the support vertical plate F6, a clamping and feeding device F9 is arranged for cutting the wire 1 and inserting it into the heat-shrink tube 2. Two sets of second slider-and-guide-rail assemblies F61, used by the upper wire feeding module F1 and the lower wire feeding module F2 in their motion, are provided on one side of the support vertical plate F6. The support moving plate F16 in the upper wire feeding module F1 and the lower wire feeding module F2 is mounted on the second slider-and-guide-rail assemblies F61. One of the first guide wheels F14 in the upper wire feeding module F1 serves as a tension adjustment wheel, located on one side of the first gear F13. The support moving plate F61 is provided with an adjustment bolt F17 for regulating this first guide wheel F14.

Additionally, the wire feeding mechanism F includes a first support frame F0 mounted on the machine frame A and a first horizontal motion module F00 arranged on the first support frame F0, capable of moving toward or away from the rotary disc transfer mechanism G. The first straightening device F7, the hand-adjustable pulley wire guide device F8, the support vertical plate F6, and the clamping and feeding device F9 are sequentially installed on the first horizontal motion module F00. A second clamping device F10 is also provided between the first straightening device F7 and the hand-adjustable pulley wire guide device F8 for clamping the wire 1. The first support frame F0 includes a lift adjustment frame F01 floatably mounted on the machine frame A and a lead screw-and-nut assembly F02 provided between the machine frame A and the lift adjustment frame F01 for adjusting height. The end of the lead screw-and-nut assembly F02 is provided with a hand crank F03 or is connected to a driving module.

The clamping and feeding device F9 includes a sliding adjustment device F91 for supporting the second positioning sleeve F5, a lifting adjustment device F92 disposed above the sliding adjustment device F91, a first cutting device F93 arranged on the lifting adjustment device F92 for cutting the wire 1, and a third wire clamping device F94 and a fourth wire clamping device F95 arranged on both sides of the first cutting device F93 for clamping the wire 1. A spacer F941 is provided on the third wire clamping device F94 and/or the fourth wire clamping device F95 to increase clamping force, and the spacer F941 is located at the connection between a clamp cylinder F942 and a clamp arm F943.

The first clamping drive device F3 includes a second gear F31, a first rack F32 and a second rack F33 arranged respectively on two sides of the second gear F31 and respectively connected to the upper wire feeding module F1 and the lower wire feeding module F2, and a first air cylinder F34 connected to the first rack F32 or the second rack F33 to push them in relative motion.

The twisting mechanism C includes a hollow rotary cylinder C1, a support arm C2 disposed on the rotating disk of the hollow rotary cylinder C1, and a fifth wire clamping device C3 arranged on the support arm C2 for clamping the wire 1. After the fifth wire clamping device C3 clamps the wire 1, it twists the wire 1 around the rotation center of the hollow rotary cylinder C1. The wire supply mechanism B includes a wire supply reel B1 arranged below the twisting mechanism C, a wire guide wheel assembly B2 disposed on one side of the twisting mechanism C for conducting the wire 1, a tension adjustment device B3 disposed between the wire guide wheel assembly B2 and the wire supply reel B1, a second straightening device B4 disposed between the twisting mechanism C and the wire guide wheel assembly B2, and a second driving device B5 for driving the wire supply reel B1 to rotate and feed the wire.

The rotary disc transfer mechanism G includes a rotary driving device G1 mounted on the machine frame A, a transfer turntable G2 arranged on the rotary driving device G1, multiple clamp modules G3 arranged around the circumference of the transfer turntable G2 for clamping the heat-shrink tube 2, and multiple first opening clamp devices G4 arranged below the transfer turntable G2 for pushing open the clamp modules G3. Each clamp module G3 includes a fixed clamp block G31 disposed on the outer edge of the transfer turntable G2, a sliding clamp block G32 capable of relative opening and closing motion with respect to the fixed clamp block G31 to clamp the heat-shrink tube 2, at least one set of first slider-and-guide-rail assemblies G33 arranged on the transfer turntable G2 for the movement of the sliding clamp block G32, an installation fixing plate G34 arranged at one end of the first slider-and-guide-rail assembly G33 for limiting and positioning the sliding clamp block G32, a return spring G35 disposed between the installation fixing plate G34 and the sliding clamp block G32 for biasing the sliding clamp block G32 toward the fixed clamp block G31, an opening clamp arm G36 disposed below the sliding clamp block G32 that can contact the first opening clamp device G4 to compress the return spring G35, and an adjustment bolt rod G37 passing through the installation fixing plate G34 and connecting with the sliding clamp block G32. The first opening clamp device G4 includes a first lift cylinder G41 and an opening clamp wedge G42 disposed on the first lift cylinder G41 for contacting the opening clamp arm G36. The lower end of the opening clamp arm G36 is provided with a roller G38 that comes into contact with the opening clamp wedge G42.

The direction-changing mechanism J includes a support upright J1 mounted on the machine frame A, a second horizontal motion module J2 disposed at the upper end of the support upright J1 and perpendicular to the transfer turntable G2, a second lifting motion module J3 mounted on the second horizontal motion module J2, a sixth wire clamping device J4 arranged on the second lifting motion module J3 for clamping the heat-shrink tube 2 and the wire 1, and a support rod J5 arranged at the lower end of the support upright J1 for supporting the heat-shrink tube 2 and the wire 1. The support rod J5 supports one end of the heat-shrink tube 2 and the wire 1 in front of the second hot air spraying mechanism K. A second opening clamp device J6 for pushing open the clamp modules G3 is arranged below the sixth wire clamping device J4.

The first hot air spraying mechanism I includes a third horizontal motion module I1 mounted on the machine frame A, a third adjusting support rod I2 mounted on the third horizontal motion module I1, a first hot air spray gun I3 disposed on the third adjusting support rod I2 for spraying hot airflow, a positioning groove plate I4 arranged below the first hot air spray gun I3 for positioning the heat-shrink tube 2 and the wire 1, a limiting baffle I5 provided beside the positioning groove plate I4 for auxiliary positioning and limiting the wire 1, and a third lift cylinder I6 for pushing the positioning groove plate I4 up and down. The limiting baffle I5 is located next to the third adjusting support rod I2 and moves along with the third horizontal motion module I1. The third adjusting support rod I2 includes a vertical adjusting rod I21 and a horizontal adjusting rod I22.

The tube supply mechanism H includes a second support frame H1 mounted on the machine frame 1 in a height-adjustable manner, a fourth horizontal motion module H2 arranged on the second support frame H1, an installation reel H3 arranged beside the fourth horizontal motion module H2 for installing a roll of heat-shrink tubes 2, a transfer module H4 arranged on the fourth horizontal motion module H2 for conveying the heat-shrink tubes 2, a cutting module H5 arranged at the front end of the transfer module H4 for cutting the heat-shrink tubes 2, and a loading positioning module H6 arranged at the front end of the cutting module H5 to cooperate with feeding. The second support frame H1 has the same structure as the first support frame F0.

The machine frame A is further equipped with a fifth horizontal motion module A1 and a sixth horizontal motion module A2 for respectively driving the rosin flux application mechanism D and the tin-dipping mechanism E to move between the twisting mechanism C and the wire feeding mechanism F to adjust their positions. Through the fifth horizontal motion module A1 and the sixth horizontal motion module A2, the positions of the rosin flux application mechanism D and the tin-dipping mechanism E can be adjusted respectively to perform tin-dipping operations on wires 1 of different requirements, thereby matching the needs of different products and greatly enhancing the versatility of the equipment.

In summary, during operation of this invention, first mount the wire reel for wire 1 and the tube reel for heat-shrink tube 2 onto the wire supply mechanism B and the tube supply mechanism H, respectively. Then pull the wire 1 from the wire supply mechanism B, passing it successively through the twisting mechanism C, the rosin flux application mechanism D, and the tin-dipping mechanism E to the wire feeding mechanism F. The wire feeding mechanism F then cuts the wire 1 and inserts it into the heat-shrink tube 2 in the rotary disc transfer mechanism G, while the tube supply mechanism H cuts the heat-shrink tube 2 and places it into the rotary disc transfer mechanism G for the wire feeding mechanism F to insert the wire 1. Furthermore, after passing through the twisting mechanism C, the wire 1 is twisted by the twisting mechanism C so that different portions of the wire 1 can be uniformly coated with rosin flux and tin, and at the same time, the twisting mechanism C imparts a twisting force to braided-type wires 1 to keep them twisted together to prevent unraveling. Certainly, during operation of the twisting mechanism C, the other end of the wire needs to be clamped by the second clamping device F10 to facilitate twisting. Next, as the wire 1 is pulled by the wire feeding mechanism F, it completes rosin flux coating by the rosin flux application mechanism D and then completes tin-dipping by the tin-dipping mechanism E. Of course, the rosin flux application region and the tin-dipping region for the wire 1 can be in the same area, and by using the fifth horizontal motion module A1 and the sixth horizontal motion module A2 to adjust the positions of the rosin flux application mechanism D and the tin-dipping mechanism E, different required positions on the wire 1 can be coated.

Furthermore, during wire feeding by the wire feeding mechanism F, the wire 1 is first straightened by the first straightening device F7, then passes through the second clamping device F10 and the hand-adjustable pulley wire guide device F8. Afterward, the first clamping drive device F3 drives the upper wire feeding module F1 and the lower wire feeding module F2 to clamp the wire 1. The first motor F15 in the upper wire feeding module F1 and the lower wire feeding module F2 then drives the first toothed belt F11 to transport the wire 1, utilizing the meshing of the first toothed belt F11 and the second toothed belt F21 to clamp and transfer the wire 1 forward. Finally, after the wire 1 is clamped by the third wire clamping device F94 and the fourth wire clamping device F95 in the clamping and feeding device F9, the wire 1 is cut by the first cutting device F93. The first horizontal motion module F00 then pushes the wire 1 into the heat-shrink tube 2 on the rotary disc transfer mechanism G.

Additionally, after being drawn from the installation reel H3 of the tube supply mechanism H, the heat-shrink tube 2 is clamped and conveyed by the transfer module H4. The loading positioning module H6 positions the heat-shrink tube 2 at the periphery of the rotary disc transfer mechanism G. After the cutting module H5 cuts the heat-shrink tube 2, it is pushed to the rotary disc transfer mechanism G via the fourth horizontal motion module H2.

Furthermore, once the heat-shrink tube 2 is transferred to the rotary disc transfer mechanism G, the clamp modules G3 clamp the heat-shrink tube 2. The rotary disc transfer mechanism G then rotates and transfers the heat-shrink tube 2 to the wire feeding mechanism F, where the wire feeding mechanism F pushes the wire 1 into the heat-shrink tube 2. Then the rotary disc transfer mechanism G moves the heat-shrink tube 2 and the wire 1 to the first hot air spraying mechanism I, which heats the heat-shrink tube 2 to adhere to the wire 1. Next, the rotary disc transfer mechanism G transfers the heat-shrink tube 2 and the wire 1 to the direction-changing mechanism J, which clamps and moves them out and lowers them so that the other end of the wire 1 and the heat-shrink tube 2 is positioned in front of the second hot air spraying mechanism K. The second hot air spraying mechanism K heats the other end of the wire 1 and the heat-shrink tube 2, causing the heat-shrink tube 2 to adhere to the other end of the wire 1. Finally, the assembled wire 1 and heat-shrink tube 2 is removed from the rotary disc transfer mechanism G.

Of course, the above descriptions are merely specific embodiments of the present invention and are not intended to limit the scope of the invention. All equivalent modifications or alterations made in accordance with the structure, features, and principles described in the appended claims of the present invention shall be included within the scope of the present invention.

We claim:

1. An automatic tin-plating sleeve insertion machine, comprising:
a wire feeding mechanism (F);
wherein the wire feeding mechanism (F) comprises an upper wire feeding module (F1) and a lower wire feeding module (F2), which are arranged in an up-down symmetrical manner for clamping a wire (1) and transferring the wire (1);
a first clamping drive device (F3) configured to drive the upper wire feeding module (F1) and the lower wire feeding module (F2) to move toward and away from each other;
a first positioning sleeve (F4) and a second positioning sleeve (F5) respectively disposed on both sides of the upper wire feeding module (F1) and the lower wire feeding module (F2) for allowing the wire (1) to pass through for positioning;
the upper wire feeding module (F1) and the lower wire feeding module (F2) are respectively provided with a first toothed belt (F11) and a second toothed belt (F21) configured to mesh with each other and press the wire (1) during transfer; and
the upper wire feeding module (F1) and the lower wire feeding module (F2) are further respectively provided with a first guide wheel (F14) and a second guide wheel (F24) for horizontally supporting the first toothed belt (F11) and the second toothed belt (F21) to achieve multi-tooth meshing and clamping of the wire (1).

2. The automatic tin-plating sleeve insertion machine according to claim 1, wherein the upper wire feeding module (F1) comprises a first support base (F12) in the shape of a “concave” character ( [symbol] ); a first toothed belt (F11) sleeved on the first support base (F12); a first gear (F13) disposed in the central recess of the first support base (F12) to drive the first toothed belt (F11) to move; four first guide wheels (F14) disposed at four corners of the first support base (F12) for the running of the first toothed belt (F11); and a first motor (F15) configured to drive the first gear (F13), wherein the toothed portion of the first toothed belt (F11) is located on an outer side and forms a U-shaped bend meshing with the first gear (F13), and the structure of the lower wire feeding module (F2) is identical to that of the upper wire feeding module (F1).

3. The automatic tin-plating sleeve insertion machine according to claim 2, wherein the wire feeding mechanism (F) further comprises a support vertical plate (F6) for supporting and positioning the upper wire feeding module (F1) and the lower wire feeding module (F2) in motion; the upper wire feeding module (F1) further comprises a support moving plate (F16) disposed in a first positioning groove of the support vertical plate (F6); the first support base (F12) and the first motor (F15) are respectively mounted on two opposite sides of the support moving plate (F16); one side of the support vertical plate (F6) is provided with a first straightening device (F7) for straightening the wire (1) that enters between the upper wire feeding module (F1) and the lower wire feeding module (F2); a hand-adjustable pulley wire guide device (F8) is disposed between the first straightening device (F7) and the first positioning sleeve (F4) for manually adjusting the wire (1); and another side of the support vertical plate (F6) is provided with a clamping and feeding device (F9) for cutting the wire (1) and inserting the wire (1) into a heat-shrink tube (2).

4. The automatic tin-plating sleeve insertion machine according to claim 3, wherein the wire feeding mechanism (F) further comprises a first support frame (F0) mounted on a machine frame (A), and a first horizontal motion module (F00) arranged on the first support frame (F0) and configured to move toward or away from a rotary disc transfer mechanism (G); the first straightening device (F7), the hand-adjustable pulley wire guide device (F8), the support vertical plate (F6), and the clamping and feeding device (F9) are sequentially mounted on the first horizontal motion module (F00); and a second clamping device (F10) for clamping the wire (1) is further disposed between the first straightening device (F7) and the hand-adjustable pulley wire guide device (F8).

5. The automatic tin-plating sleeve insertion machine according to claim 3, wherein the clamping and feeding device (F9) comprises a sliding adjustment device (F91) for supporting the second positioning sleeve (F5), a lifting adjustment device (F92) disposed above the sliding adjustment device (F91), a first cutting device (F93) arranged on the lifting adjustment device (F92) for cutting the wire (1), and a third wire clamping device (F94) and a fourth wire clamping device (F95) arranged on two sides of the first cutting device (F93) for clamping the wire (1); a spacer (F941) is provided on the third wire clamping device (F94) and/or the fourth wire clamping device (F95) for increasing clamping force; and the spacer (F941) is located at a connection between a clamp cylinder (F942) and a clamp arm (F943).

6. The automatic tin-plating sleeve insertion machine according to claim 1, wherein the first clamping drive device (F3) comprises a second gear (F31); a first rack (F32) and a second rack (F33) respectively arranged on two sides of the second gear (F31) and respectively connected to the upper wire feeding module (F1) and the lower wire feeding module (F2); and a first air cylinder (F34) connected to the first rack (F32) or the second rack (F33) for pushing the first rack (F32) and the second rack (F33) to move relative to each other.

7. The automatic tin-plating sleeve insertion machine according to claim 6, wherein the wire feeding mechanism (F) is disposed in a middle portion of a machine frame (A), and the machine frame (A) is further provided with a wire supply mechanism (B), a twisting mechanism (C), a rosin flux application mechanism (D), a tin-dipping mechanism (E), a rotary disc transfer mechanism (G), a tube supply mechanism (H), a first hot air spraying mechanism (I), a direction-changing mechanism (J), and a second hot air spraying mechanism (K); the tube supply mechanism (H), the wire feeding mechanism (F), the first hot air spraying mechanism (I), and the direction-changing mechanism (J) are sequentially arranged around a periphery of the rotary disc transfer mechanism (G); the second hot air spraying mechanism (K) is located below the direction-changing mechanism (J); the rosin flux application mechanism (D) and the tin-dipping mechanism (E) are located between the wire feeding mechanism (F) and the twisting mechanism (C); the wire supply mechanism (B) provides the wire (1) to the wire feeding mechanism (F) via the twisting mechanism (C), the rosin flux application mechanism (D), and the tin-dipping mechanism (E); the tube supply mechanism (H) provides a heat-shrink tube (2) to the rotary disc transfer mechanism (G); and the first hot air spraying mechanism (I) and the second hot air spraying mechanism (K) heat and bond two ends of the heat-shrink tube (2) sleeved on the wire (1).

8. The automatic tin-plating sleeve insertion machine according to claim 7, wherein the twisting mechanism (C) comprises a hollow rotary cylinder (C1); a support arm (C2) disposed on a rotating disk of the hollow rotary cylinder (C1); and a fifth wire clamping device (C3) disposed on the support arm (C2) for clamping the wire (1), wherein after the fifth wire clamping device (C3) clamps the wire (1), the fifth wire clamping device (C3) twists the wire (1) around a rotational center of the hollow rotary cylinder (C1); and the wire supply mechanism (B) comprises a wire supply reel (B1) arranged below the twisting mechanism (C); a wire guide wheel assembly (B2) disposed to one side of the twisting mechanism (C) for guiding the wire (1); a tension adjustment device (B3) arranged between the wire guide wheel assembly (B2) and the wire supply reel (B1); a second straightening device (B4) arranged between the twisting mechanism (C) and the wire guide wheel assembly (B2); and a second driving device (B5) configured to drive the wire supply reel (B1) to rotate and feed the wire (1).

9. The automatic tin-plating sleeve insertion machine according to claim 7, wherein the rotary disc transfer mechanism (G) comprises a rotary driving device (G1) mounted on the machine frame (A), a transfer turntable (G2) disposed on the rotary driving device (G1), multiple clamp modules (G3) arranged around a circumference of the transfer turntable (G2) for clamping the heat-shrink tube (2), and multiple first opening clamp devices (G4) arranged below the transfer turntable (G2) for pushing the clamp modules (G3) to open; each clamp module (G3) comprises a fixed clamp block (G31) disposed on an outer edge of the transfer turntable (G2) and a sliding clamp block (G32) capable of relative opening and closing movement for clamping the heat-shrink tube (2); at least one set of first slider-and-guide-rail assemblies (G33) is disposed on the transfer turntable (G2) for movement of the sliding clamp block (G32); an installation fixing plate (G34) is arranged at one end of the first slider-and-guide-rail assembly (G33) for limiting and positioning the sliding clamp block (G32); a return spring (G35) is disposed between the installation fixing plate (G34) and the sliding clamp block (G32) to bias the sliding clamp block (G32) toward the fixed clamp block (G31); an opening clamp arm (G36) is disposed below the sliding clamp block (G32) and is configured to contact the first opening clamp device (G4) to compress the return spring (G35); and an adjustment bolt rod (G37) passes through the installation fixing plate (G34) and connects to the sliding clamp block (G32).

10. A method for automatically tin-plating and inserting a sleeve, the method comprising:
providing a heat-shrink tube (2) by a tube supply mechanism (H), cutting the heat-shrink tube (2), and transferring the cut heat-shrink tube (2) onto a rotary disc transfer mechanism (G);
providing a wire (1) by a wire supply mechanism (B), routing the wire (1) through a twisting mechanism (C), a rosin flux application mechanism (D), and a tin-dipping mechanism (E), and then cutting the wire (1) by a wire feeding mechanism (F) before inserting the wire (1) into the heat-shrink tube (2) on the rotary disc transfer mechanism (G);
applying rosin flux onto the surface of the wire (1) via the rosin flux application mechanism (D) and applying solder onto the surface of the wire (1) via the tin-dipping mechanism (E), wherein, during said routing, the twisting mechanism (C) clamps and twists the wire (1) to ensure coverage of rosin flux and solder on the outer surface of the wire (1);
clamping a front end of the wire (1) between an upper wire feeding module (F1) and a lower wire feeding module (F2) of the wire feeding mechanism (F), driving the upper wire feeding module (F1) and the lower wire feeding module (F2) to push the wire (1) forward, passing the wire (1) through a clamping and feeding device (F9), and inserting the wire (1) into the heat-shrink tube (2) on the rotary disc transfer mechanism (G) before cutting the wire (1) via the clamping and feeding device (F9);
rotating the wire (1) inserted into the heat-shrink tube (2) by the rotary disc transfer mechanism (G) to a first hot air spraying mechanism (I), and heating one end of the heat-shrink tube (2) and the wire (1) so that the heat-shrink tube (2) wraps and adheres to the wire (1);
rotating the wire (1) inserted into the heat-shrink tube (2) by the rotary disc transfer mechanism (G) to a direction-changing mechanism (J), clamping and removing the wire (1) and the heat-shrink tube (2) from the rotary disc transfer mechanism (G), lowering the wire (1) and the heat-shrink tube (2) so that another end of the heat-shrink tube (2) is positioned before a second hot air spraying mechanism (K), and heating said other end of the heat-shrink tube (2) and the wire (1) so that the heat-shrink tube (2) is partially or fully wrapped and adhered to the wire (1); and
discharging, from the direction-changing mechanism (J), the wire (1) and the heat-shrink tube (2) once sleeve bonding is completed.
